(19) United States
(12) Patent Application Publication
(10) Pub. No.: US 2009/0044258 A1
(43) Pub. Date: Feb. 12, 2009

(54) COMMUNICATION METHOD AND SERVICE IN PERSONAL AREA NETWORK

(75) Inventors: Yongfeng Zhong, Shenzhen (CN); Ling Zhang, Shenzhen (CN); Ling Liu, Shenzhen (CN)

Correspondence Address: DARBY & DARBY P.C., P.O. BOX 770, Church Street Station, New York, NY, 10008-0770, US

(73) Assignee: Huawei Technologies Co., Ltd., Shenzhen (CN)

(21) Appl. No.: 12/250,529

(22) Filed: Oct. 13, 2008

Related U.S. Application Data
(63) Continuation of application No. PCT/CN2007/001158, filed on Apr. 10, 2007.

(30) Foreign Application Priority Data
Apr. 11, 2006 (CN) 200610025599.X

(51) Int. Cl. H04L 9/32; H04W 4/00

(52) U.S. Cl. 726/4; 370/338

(57) ABSTRACT

The present invention provides a communication method and device in personal area network, the method for communication between device in a PAN includes: a central device in the PAN receives from a first device in the PAN a communication request for communication with a second device in the PAN; the central device authenticates the first device and the second device; and a point-to-point connection is established between the first device and the second device. Since no access to the access network and the core network is needed during security authentication, thus reducing the signaling traffic of the access network and the core network.

This application claims priority to Chinese Patent Application NO. 200610025599.X, entitled “PERSONAL AREA NETWORK AND COMMUNICATION METHOD FOR DEVICE IN THE NETWORK” and filed with the Chinese Patent Office on Apr. 11, 2006, contents of which are hereby incorporated by reference.

### FIELD OF THE INVENTION

The present invention relates to communication technologies and in particular to communication technologies for devices in a Personal Area Network.

### BACKGROUND OF THE INVENTION

In recent years, with the development of science, technology and increasing demand of users for high-technology products, as well as more and more peripheral devices owned by people, a user may not only possess numbers of portable computers and mobile phones at the same time, but also need to connect peripheral devices such as a printer, a scanner, an MODEM, to his/her own PC, sometimes even to plug in a USB interface so as to transfer pictures from a digital camera to store in a hard disk. Frequent plugging in and out of the interface and numerous cables behind a PC make a user feel uncomfortable while enjoying the new technologies. Further, information communication among staffs from various departments within an enterprise also poses higher requirements on mobility of information transfer. In a limited office environment, a Local Area Network can be built for sharing information and sharing devices (e.g., a printer, a scanner, etc.), but messed-up wiring brings inconvenience.

In view of this situation, the academic circles have proposed a new concept of Personal Area Network (PAN). A PAN is a mobile communication network providing wireless communication for a specific group in an area of a relatively small radius of action and of abundant service categories. It is a wireless network which is parallel to a Wide Area Network and a Local Area Network, but of a relatively small range.

An essential principle of a PAN is to use radio or infrared rays instead of conventional wire to implement smart interconnection between personal information terminals, and thus to construct a personalized information network. The PAN is a Local Area Network in the view of a computer network and an access network in the view of a telecommunication network. Thus, the PAN is regarded as a solution for the “last meter” of a telecommunication network.

Application scenarios of the PAN are home and small office. Major application scenarios of the PAN include a voice communication gateway, a data communication gateway, information appliance interconnection, automatic information exchange, etc.

Technologies for implementing a PAN mainly include Bluetooth, infrared communication technology of Infrared Data Association (IRDA), etc.

With a PAN, all closely located devices of a same user can exchange information conveniently. Devices of the same user or a PAN constitute a user network for the user. The user manages devices in his or her user network by means of a managing entity. A so-called managing entity is a logic entity for managing all the devices in the user network. Each user has a corresponding managing entity, and this entity is typically located in a core network and is operated and maintained by the user through a piece of device. Major function of a managing entity is to register, deregister, activate and deactivate a device of the user and to direct a service.

When building a PAN, a PAN ID is firstly selected by device 0. This device thus becomes a central device. Then the central device 0 selects an idle channel as an operating channel to form the PAN, and further performs authentication on device information and user number at the managing entity through an access network to get authorization. Other devices such as device 1 and device 2 find the PAN ID of the PAN through scanning, and can request to join the PAN. The device 1 and the device 2 which join the same PAN may chose not to join the user network, or chose to send information on the device 1 and the device 2 to the managing entity through the central device 0 for authentication, and join the user network upon passing authentication.

FIG. 1 shows the communication between individual device in a same PAN in the prior art. The device 1 and the device 2 is in the same PAN, and all the devices in the PAN access an access network A via the central device 0 and then access a core network via the access network A. Prior to starting communication with the device 2, the device 1 firstly requests the managing entity via the central device 0 and the access network A for point-to-point transmission with the device 2. The managing entity initiates a request for establishing transmission upon acknowledgement of validity of the device 1 and the device 2. Upon receiving the request, the device 2 feeds back acceptance information to the managing entity if this communication is allowed. The managing entity notifies the device 1 of the acceptance information, and the session request is thus finished. Then, the device 1 establishes a direct point-to-point connection with the device 2 by means of the acceptance information notified by the managing entity, and both the device 1 and device 2 start communication.

### SUMMARY OF THE INVENTION

An embodiment of the invention provides a method for communication between device in a PAN includes: a central device in the PAN receives from a first device in the PAN a communication request for communication with a second device in the PAN; the central device authenticates the first device and the second device; and a point-to-point connection is established between the first device and the second device.

An embodiment of the invention provides a authenticating device in a Personal Area Network (PAN), the authenticating device can be identified by an access network, and the authenticating device comprises: a transceiver module adapted to receive from a first device in the PAN a communication request for communication with a second device in the PAN; a storage module adapted to store authentication information of the first device and the second device; and an authentication module adapted to authenticate the first device and the second device.

An embodiment of the invention provides a Personal Area Network (PAN) comprises a first device, a second device and a central device, the first device send to the central device a communication request for communication with the second device; the central device can be identified by an access network, and store authentication information of the first device and the second device; the central device authenticate the first device and the second device based on the communication request received from the first device and the authentication information locally stored.

### BRIEF DESCRIPTION OF THE DRAWINGS

FIG. 1 is a schematic diagram of a communication method between devices in a same PAN of prior art;

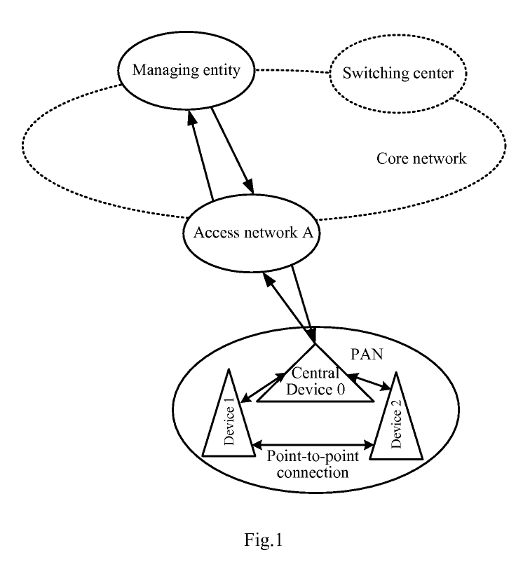

FIG. 2 is a flow chart of a communication method for devices in a PAN according to a first embodiment of the invention; and

FIG. 3 is a schematic diagram of the architecture of a PAN according to a third embodiment of the invention.

### DETAILED DESCRIPTION OF THE INVENTION

The inventors of the present invention have identified in a practical application that extra signaling is required for control of communication between various devices in a same PAN. The extra signaling unnecessarily occupies channel resources and adds a burden to the managing entity.

In the prior art, various devices in a same PAN are authenticated via the managing entity for each communication, which considerably adds the burden on the managing entity. Further, the communication requests are transferred to the managing entity through the access network to which the PAN has an access, and the authentication message from the managing entity are fed back to the device requesting communication through the access network. The control signaling for the series of actions adds a burden on channels between the PAN and the access network and between the access network and the core network in which the managing entity is located, and unnecessarily occupies channel resources.

The invention will be described further in details with reference to the drawings to make the objects, aspects and advantages of the invention more apparent.

A communication for method between devices in a PAN according to a first embodiment of the invention will be described in light of the principle of the invention.

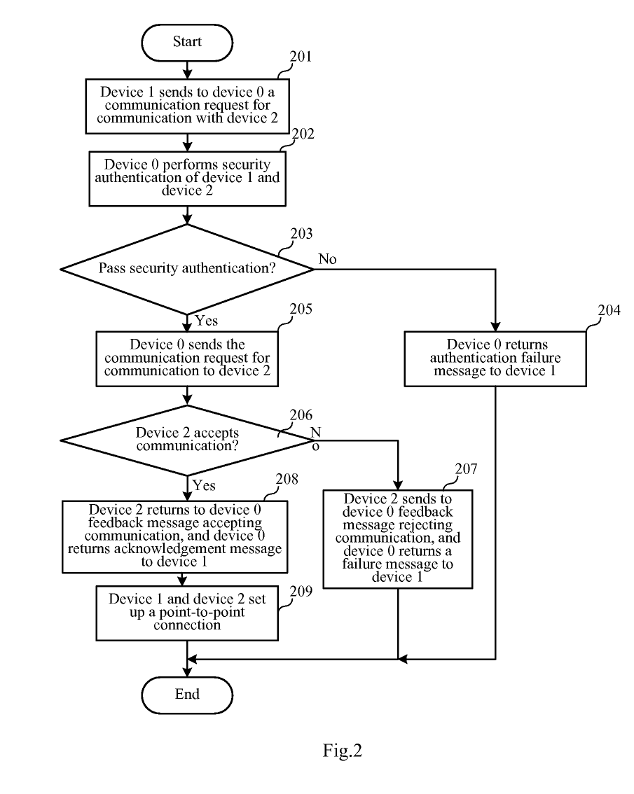

As illustrated in FIG. 2, the communication method for devices in a PAN includes the following:

In block 201, when the device 1 needs to communicate with the device 2 in a same PAN, the device 1 sends to the device 0 in the PAN a communication request for communication with the device 2. The device 0 is designated as central device in the PAN that can be identified by an access network, and the communication request sent from the device 1 to the central device includes device identifiers of the device 1 and the device 2.

In block 202, the device 0 performs security authentication on the device 1 and the device 2. Specifically, upon receiving the communication request sent from the device 1, the device 0 performs identification authentication on the device 1 and the device 2 based on the device identifiers of the device 1 and the device 2 in the request and authentication information of the device 1 and the device 2 stored locally. The authentication information includes a device identifier for each device and an identifier of a user network to which the device belongs. During authentication, the device 0 determines whether the user network identifiers respectively corresponding to the identifiers of the device 1 and the device 2 in the communication request are identical based on the authentication information, and if so, the authentication succeeds; otherwise, the authentication fails. The identifier of the user network in the authentication information is optional, and whether the device 1 and the device 2 are in the same user network can be determined upon other information during authentication. In the present embodiment, for example, if the identifiers in the authentication information stored at the device 0 belong to a same PAN, then the devices will definitely be in the same user network, and thus the identifier of the user network can be omitted in the authentication information.

The authentication information stored in the device 0 is automatically obtained from individual device in the PAN and stored by the device 0 when this device accesses the access network via the device 0. Thus, no additional procedure is needed to obtain authentication information of the respective device in the PAN.

For device in a same PAN, an authentication function implemented on a managing entity previously is now implemented on a central device in each PAN of the managing entity, so that the burden on the managing entity is reduced while secured communication between individual device in the same PAN is ensured. The slightly added burden to the central device in each PAN will not influence the original performance of the central device. Further, since individual central device in need of communication in the same PAN is authenticated at the central device in the PAN, it is not necessary for the device to access the access network and the core network for security authentication, and thus signaling traffic between the access network and the core network is reduced effectively.

In block 203, the device 0 determines whether the device 1 and the device 2 pass authentication, and if so, block 205 is executed; otherwise block 204 is executed.

In block 204, the device 0 returns an authentication failure message to the device 1.

In block 205, the device 0 sends to the device 2 a communication request notifying the device 2 that the device 1 in the same PAN requests communication with it.

In block 206, the device 2 determines whether to accept the communication upon receiving the communication request, and if so, block 208 is executed; otherwise, block 207 is executed.

In block 207, the device 2 returns to the device 0 a feedback message of rejecting the communication, and the device 0 forwards a failure message that the device 2 rejects communication to the device 1 that initiates this communication.

In block 208, the device 2 returns to the device 0 a feedback message of accepting the communication, and upon receiving this message, the device 0 sends to the device 1 initiating this communication an acknowledgement message indicating that the device 2 allows this communication. The acknowledgement message includes information on a data transmission link between the device 1 and the device 2.

In block 209, upon receiving the acknowledgement message, the device 1 directly establishes a point-to-point connection to the device 2 in the PAN for communication based on the information on the data transmission link.

In the present embodiment, the device 0 can also report a communication record to the managing entity at a predetermined cycle. The communication record includes the device identifiers of the devices in communication with each other, the time when the communication is initiated, a service type of communication, etc., so that the managing entity can enforce better management on the respective devices in the PAN based on the communication record.

A method for communication between devices in a PAN according to a second embodiment of the invention is similar to that according to the first embodiment except that the central device in the first embodiment reports a communication record to the managing entity at a predetermined cycle, while in the second embodiment, the central device does not report a communication record periodically, instead, the managing entity in need of a communication record sends to the central device a request message requesting to report a communication record. The request message can carry various parameters, so that only part of the communication record with interests for the managing entity is reported, such as a parameter of period-of-time, a device identifier, and the central device reports the relevant communication record to the managing entity based upon the request message.

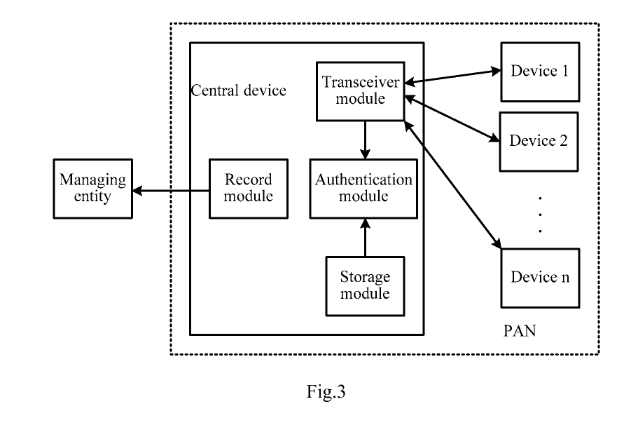

A PAN according to a third embodiment of the invention as illustrated in FIG. 3 includes a plurality pieces of devices, and one of the pieces is a central device that can be identified by an access network. The central device further includes a transceiver module for exchanging information with other device, a storage module for storing authentication information of the respective devices in the PAN, an authentication module for authenticating a device in need of communication in the PAN and a record module for recording communications of the respective devices in the PAN.

Preferably, the central device is the device 0, and other devices in the PAN access the access network via the device 0. The device 0 automatically obtains authentication information from respective devices and stores the authentication information, and thus no additional procedure is needed to obtain the authentication information of the respective devices in the PAN. The central device can also be another device that can be identified by the access network. Specifically, when a device in the PAN needs a communication, the device 1 initiating the communication sends to the central device a communication request for communicating with the device 2. Upon receiving the communication request from the device 1 via the transceiver module, the central device authenticates the device 1 and the device 2 by means of the authentication module based on the communication request and the authentication information in the storage module. If the authentication succeeds, the central device instructs the device 1 and the device 2 through the transceiver module to directly establish a point-to-point connection in the PAN. In this procedure, the central device also records communications of respective devices in the PAN by means of a record module, and reports the communication record to the managing entity through the transceiver module periodically or upon receiving a request from the managing entity, thereby notifying the managing entity of device identifiers of both parties in communication, the time when the communication is initiated, a service type of the communication, etc.

As can be seen from the foregoing embodiments, the central device obtains authentication information of an individual device in the PAN when the device accesses the access network via the central device, and stores the authentication information in the central device, so that the authentication information of the other device in the PAN can be obtained automatically during an access without any extra procedure.

The central device stores a communication record for individual device in the PAN in which the central device is linked, and reports the communication record to the managing entity periodically or upon receiving a request message from the managing entity to facilitate the managing entity to manage the respective devices in the PAN based on the communication record.

According to the embodiments of the invention, in the case that devices between which a point-to-point communication is to be setup are in a same PAN, security authentication of the devices is implemented in the central device that can be identified by the access network instead of in the managing entity. By implementing the authentication function in the central device instead of in the managing entity, the burden on the managing entity is reduced while secure communication between devices in the PAN is ensured. Since the central device and the devices between which point-to-point communication is to be setup are in a same PAN, no access to the access network and the core network is needed during security authentication, thus reducing the signaling traffic of the access network and the core network.

Although the invention has been illustrated and described in connection with some preferred embodiments thereof, those skilled in the art shall appreciate that various modifications can be made in forms and details without departing from the spirit and scope of the invention.

1. A method for communication between devices in a Personal Area Network (PAN) comprising:
receiving, by a central device in the PAN, from a first device in the PAN a communication request for communicating with a second device in the PAN,
authenticating, by the central device, the first device and the second device; and
establishing a point-to-point connection between the first device and the second device.

2. The method according to claim 1, wherein the central device authenticates the first device and the second device based on the communication request and authentication information stored in the central device.

3. The method according to claim 2, wherein the authentication information comprises a device identifier, or the device identifier and an identifier of a user network to which the device belongs;
the communication request comprises the device identifiers of the first device and the second device.

4. The method according to claim 2, wherein the central device obtains and stores the authentication information before receiving the communication request.

5. The method according to claim 1, wherein the step of establishing a point-to-point connection in the PAN comprises: receiving, by the central device, an acknowledgement message from the second device, and sending the acknowledgement message to the first device.

6. The method according to claim 5, wherein the acknowledgement information comprises information on a data transmission link between the first device and the second device, the point-to-point connection is established based on the information on the data transmission link.

7. The method according to claim 1, further comprising:
recording, by the central device, information on communications between the first device and the second device; and reporting the information to a managing entity.

8. An authenticating device in a Personal Area Network (PAN), the authenticating device can be identified by an access network, wherein the authenticating device comprises:
a transceiver module adapted to receive from a first device in the PAN a communication request for communication with a second device in the PAN;
a storage module adapted to store authentication information of the first device and the second device; and
an authentication module adapted to authenticate the first device and the second device.

9. The authenticating device according to claim 8, wherein the authentication module authenticates the first device and the second device based on the communication request received by the transceiver module and the authentication information stored by the storage module.

10. The authenticating device according to claim 8, further comprising:
a record module adapted to record information on communications between the first device and the second device.

11. A Personal Area Network (PAN) comprising a first device, a second device, and a central device which can be identified by an access network, wherein:
the first device is adapted to send to the central device a communication request for communication with the second device;
the central device is adapted to store authentication information of the first device and the second device; and
the central device is adapted to authenticate the first device and the second device based on the communication request received from the first device and the authentication information stored in the central device.
